(19) United States
(12) Patent Application Publication
(10) Pub. No.: US 2004/0020391 A1
(43) Pub. Date: Feb. 5, 2004

(54) Method for controlling a circumferential register in a web-fed rotary press

(76) Inventors: Erhard Herbert Glockner, Eibelstadt (DE); Reinhard Georg Gross, Dettelbach (DE)

Correspondence Address: Douglas R Hanscom, Jones Tullar & Cooper, Eads Station, PO Box 2266, Arlington, VA, 22202, US

(21) Appl. No.: 10/416,526

(22) PCT Filed: Nov. 21, 2001
(86) PCT No.: PCT/DE01/04368

(30) Foreign Application Priority Data
Nov. 27, 2000 (DE) 100 58 841.7

(51) Int. Cl. B41L 1/02

(52) U.S. Cl. 101/485

(57) ABSTRACT

The invention relates to a method for controlling a circumferential register in a web-fed rotary press, according to which an actual value pertaining to a tension (51-55) of a web (03) passing through the printing units (04, 06, 07, 08) is determined, and an angular position and/or an angular velocity of a cylinder (12, 16) of a first printing unit (04) with regard to a cylinder of a second printing unit (06) is changed according to this determined tension. The correction of a register offset ensues without controlling the tension (51-55) and without the use of an optical recognition system by determining the value of the necessary change for the angular position (δφ) and/or the angular velocity (δφ) as a function of the measured tension (51-55) of the web (03).

The invention relates to a method for regulating a circumferential register in accordance with the preambles of claims 1, 3, 5 or 10.

A regulation of the transverse and linear register is known from EP 0 951 993 A1, wherein the correction of the transverse register is performed by means of a traction roller. A change in the linear expansion is determined by means of web speeds and other parameters, such as tension-expansion diagrams and set values of tension, and is transmitted back to regulation arrangements for cylinders of the printing groups and/or for an actuator for setting and correcting the cutting register.

WO 00/34042 discloses a method for regulating a register wherein a deviation of a web tension from a set value changes the number of revolutions and/or angular position of a first printing location in relation to a second printing location.

EP 0 950 519 A1 discloses a method for regulating the cutting and inking registers of several webs in respect to each other, as well as between the individual print units. Expansions are determined by means of the operating points of the drive mechanisms of conveying rollers, active cylinders and traction rollers, and correcting values determined from this are added as position offsets to the command variables for the cutting register or the inking register.

The object of the invention is based on providing methods for regulating a circumferential register.

In accordance with the invention, this object is attained by means of the characteristics of claims 1, 3, 5 or 10.

The advantages which can be obtained by means of the invention reside in particular in that an error in the circumferential register, which is the result of tension fluctuations or of fluctuations of the circumference of the printing cylinder caused, for example, by brief changes in the thickness of the web, is counteracted without a great outlay for measuring and regulating. The error to be corrected can be a register offset (an error in the so-called inking register), or a register error between the two sides of the imprinted web. A difference in the conveying speed of the web occurring between two print positions is corrected by means of a change of the relative rotary position of the print positions in respect to each other.

It is a great advantage that it is possible to omit elaborate measurements and regulations by means of ink markers applied to the web. Neither a direct measurement of the expansion, nor a regulation of the tension or torque by means of the operating points of the drive mechanisms of the print units for the purpose of a correction needs to be performed.

The method, and a corresponding device, can be employed particularly advantageously in case of a register offset in print units with several double printing groups arranged one behind or one on top of the other for a rubber-against-rubber operation, such as in an eight-unit printing tower composed of two so-called H-print units, wherein at least two of the printing locations make successive imprints on the same location of a web.

For eight-unit towers consisting of two H-printing groups it is particularly advantageous to evaluate the chronological change of the tension of the web (for example before or after passing through a gluing station for the web) downstream of the last printing group, or the last print unit, and to perform only a change of the angular position of the H-print unit which is first in the running direction of the web in relation to the second H-print unit. In general, this regulation of the circumferential register, in particular the ink register, is advantageous for several, for example at least three, print units through which a web successively passes, wherein a distance between the two first nips is clearly less than a subsequent distance from a third nip. The eight-unit tower consisting of two H-print units is an example for this.

The method can be advantageously used for regulating the register between the two sides of the web in printing presses having satellite print units.

In one embodiment it is of particular advantage that a chronological change of the tension downstream of the last print unit, i.e. a difference in the tension at a first and a second point in time, is used directly and linearly for the correction of the register offset of the second H-print unit in relation to the first. This requires an extremely low measuring and regulating outlay, while still being sufficiently accurate.

It is possible in an advantageous manner to omit a tension regulation, for example by means of a moment-controlled traction roller downstream of the printing tower. An unregulated traction roller with a controlled number of revolutions is sufficient here. A register offset, for example caused in a gluing station, is corrected in an advantageous manner exclusively by means of the circumferential register of the cylinders, in particular the cylinders of the first print unit, or of the first two print units. It is possible in particular to regulate the two first print units, for example in the form of an H-print unit, together, so that it is merely necessary to determine a single correction value and to perform a single correction.

An exemplary embodiment of the invention is represented in the drawings and will be described in greater detail in what follows.

Shown are in:

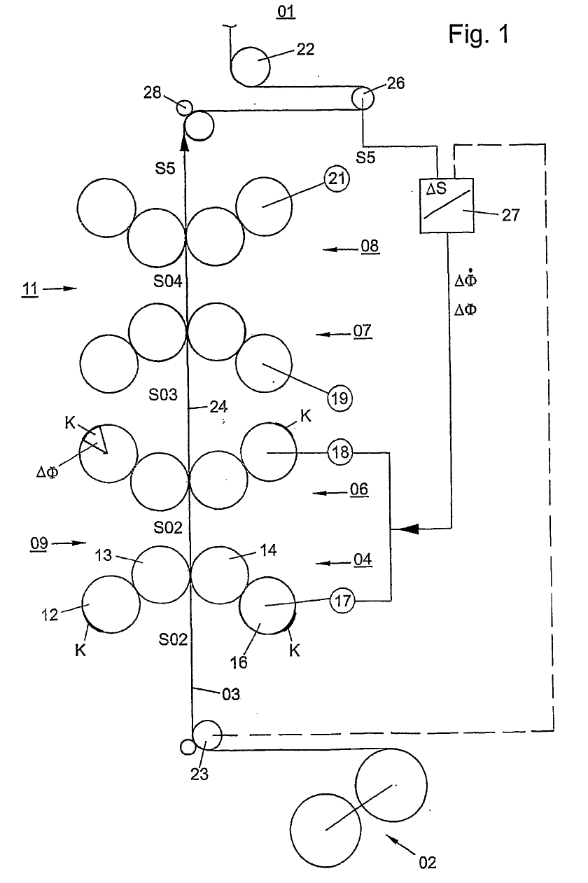

FIG. 1, a schematic representation of a print unit with a roll changer,

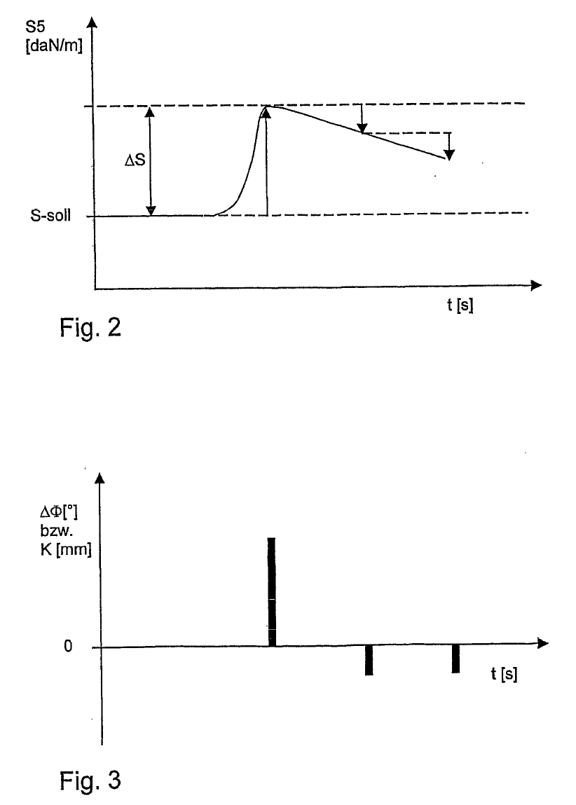

FIG. 2, a schematic representation of the tension as a function of time in the course of a passage through a gluing station,

FIG. 3, a schematic representation of a correction value, or a change in the angle of rotation, as a function of time.

A web-fed rotary printing press has, for example, an eight-unit tower 01 and a roll changer 02. During the printing operation, a web 03, for example a paper web 03, travels from the roll changer 02, for example via a draw-in device, not represented, through the eight-unit tower 01.

The eight-unit tower 01 has a total of four print units 04, 06, 07, 08, which are identical with four nips 04, 06, 07, 08. In the example, these units 04, 06, 07, 08 are embodied as double printing groups 04, 06, 07, 08, which work in a rubber-against-rubber operation during printing. Two of the print units 04, 06 are arranged within a first, in the example lower, H-print unit 09, and the other two print units 07, 08 within a second, in the example upper, H-print unit 11. Each one of the print units 04, 06, 07, 08 has at least three, in the example four, cylinders 12, 13, 14, 16, for example a first forme cylinder 12, a transfer cylinder 13 working together with the first forme cylinder 12, a counter-pressure cylinder 14 working together with the transfer cylinder 13 via the paper web 03, and, if the counter-pressure cylinder 14 is embodied, as it is here, as a second transfer cylinder 14, a second forme cylinder 16 working together with the latter.

In the example, each one of the print units 04, 06, 07, 08 has at least one drive motor 17, 18, 19, 21. However, each cylinder 12, 13, 14, 16 of each print unit 04, 06, 07, 08, or respectively of each pair of transfer cylinders 13, 14 and forme cylinders 12, 16 together, can have a drive motor. It is however also possible that the lower H-print unit 09 constitutes a compound unit driven by means of drive motors 17, 18, and the upper H-print unit 11 a compound unit driven by means of drive motors 19, 21. A traction roller 22 is arranged downstream of the last print unit 08. A draw-in device 23 (symbolized by a traction roller) is arranged between the roll changer 02 and the first print unit 04. Not represented inking systems and, if required dampening systems, are assigned to each of the print units 04, 06, 07, 08.

In the travel of the paper web 03 from the roll changer 02 as far downstream as the last print unit 08, viewed in the running direction of the paper, of the eight-unit tower 01, tensions S1, S2, S3, S4, S5 exist. The tension S1 prevails upstream of the eight-unit tower 01, for example S1 lies between 30 and 50 daN/m, between the print units 04 and 08 the tension S2, between the first H-print unit 09 and the second H-print unit 11 the tension S3, between the print units 07 and 08 the tension S2, and downstream of the last print unit 06 the tension S5, for example, S5 lies between 10 and 20 daN/m, in particular 12 to 15 daN/m. The exact levels and the accurate differences, however, are based on the water sensitivity of the paper used. The considerably higher level of the tension S1 in comparison to S5 is essential. A regulation of the tension is performed, for example, by means of the draw-in device 23.

In the course of passage through the eight-unit tower 01, the tension-expansion characteristics of the paper web 03 change as a result of moisture (ink, possibly dampening agent). The tension levels upstream and downstream of the eight-unit tower 01 will advantageously be selected in such a way that an expansion upstream and downstream of the eight-unit tower 01 is approximately equal. As a rule, the tension S1 is higher than the tension S5.

If now a change of a roll takes place in the roll changer 02 under fixed production conditions, in particular a flying change by means of gluing, a glued joint moves along with the paper web 03 from the roll changer 02 through the eight-unit tower 01. For example, the glued joint has an area of two layers of the paper web 03 and an adhesive layer, for example an adhesive strip. A so-called adhesive slip, i.e. an area of two paper layers, can extend far past the width of the glued joint. Therefore the paper web 03 has an area 24 of increased thickness which moves through the printing press.

If now the area 24 of increased thickness passes through a print unit 04, 06, 07, 08, an elastic cover on the cylinders 13, 14, for example rubber blankets, is slightly compressed because of the increased thickness and the fixed axial distance of the cylinders 13, 14 working together. At a constant angular speed, the circumferential speed of the cylinders 13, 14 is reduced. For example, the higher circumferential speed still prevails in the print unit 07, while simultaneously the circumferential speed in the print unit 06 is reduced during the passage of the area 24. Thus, the level of the tensions S2, S3, S4, S5 suddenly increases between the print units 04, 06, 07, 08 and downstream of the eight-unit tower 01 (FIG. 2 regarding the tension S5).

The increased level of the tensions S2, S3, S4, S5 is accompanied by an increased level of the expansion of the paper web 03, and therefore causes an offset Delta P in the circumferential direction between the individual print units 04, 06, 07, 08, a so-called register offset in the circumferential register.

The sudden increase of the tensions S2, S3, S4, S5, and therefore also of the expansion, is a function of the original level of the tensions S, S2, S3, S4, S5, in particular of a difference between S1 and S5, and of the length of the adhesive tail, i.e. of the length of the area 24 of increased thickness. The latter in particular in connection with staggered cylinders, i.e. several channels on a shell surface of a cylinder are arranged next to each other in the axial direction, but offset in respect to each other in the circumferential direction. If in this case the length of the adhesive tail is greater than or equal to the distance between the channels in the circumferential direction, a partial relief can take place.

The sudden increase of the tension S2, S3, S4, in particular of the tension S5, over a set value S-soll downstream of the eight-unit tower 01, for example by a difference Delta S (FIG. 2) before and after the passage of the area 24, is detected by means of a measuring device 26 and a regulating device 27 and is further processed.

A correction value K is determined from this difference Delta S, and the register offset Delta P, which had occurred between two print units 04, 06, 07, 08, or between two H-print units 09, 11. As a rule, this compensation takes place by a relative change Delta phi of an angular position phi, for example the angle of rotation position phi, of the H-print units 09, 11 under consideration, or of the cylinders 12, 13, 14, 16 of the print units 04, 06, 07, 08 under consideration, in respect to each other.

In the example, the tension S5 is determined by means of a measuring arrangement 26, for example a sensor 26 such as, for example, a measuring roller 26, downstream of the eight-unit tower 01, in this case following a capture roller 28, and is fed to the regulating device 27, a computer 27, or to the control station computer 27. From the difference Delta S, the regulating device 27, or the computer 27, determines the mean correction value between the lower H-print unit 09 and the upper H-print unit 11. The angle of rotation position phi of the lower H-print unit 09, in particular that of the forme cylinders 12, 16 of the print units 04 and 06, is now rotated by means of a corresponding change Delta phi of the angle of rotation phi in relation to the lower H-print unit 09, in particular the forme cylinders 12, 16 of the latter, and the registration offset Delta P, which had occurred, is corrected in this way. Since in the example no tension regulation occurs by means of the traction roller 22, or of another arrangement, for example a compensation roller, downstream of the last print unit 08 as far as the included traction roller 22, the tension S5 slowly drops in the course of the further conveyance of the paper web 03 through the print units 04, 06, 07, 08. In the course of the drop, the circumferential register is corrected in the opposite direction by means of the correction value K in accordance with the changing difference Delta S between S5 and S-soll (FIG. 3). In an advantageous manner this does not take place continuously, but at suitable intervals.

In the present examplary embodiment of the eight-unit tower 01, no correction between the two adjoining print units 04, 06, or 07, 08, assigned to the same H-print unit 09, 11 is performed, only a relative angle of rotation position phi between the lower and upper H-print unit 09, 11 is taken into consideration as a change Delta phi in the angle of rotation position phi. In the course of this, the relative angle of rotation position phi of at least one cylinder, in case of double printing groups 04, 06 of at least two cylinders 12, 13, 14, 16, in an advantageous manner of the respective forme cylinders 12, 16, is changed. The deviation between the print units 04, 06, Or 07, 08 assigned to a single H-print unit 09, 11, lies within the permissible tolerances for a deviation in the registration, in particular in connection with newspaper printing.

The described regulation of the circumferential register is generally advantageous for at least three print units 04, 06, 07, 08 arranged one behind the other, wherein a distance a1 (for example 0.4 m to 1 m) between the first two nips 04, 06 is clearly less than a subsequent distance a2 (for example>1 m) to a third nip 07. An example of this is the eight-unit tower 01 consisting of two H-print units 09, 11. The effects of moisture, and therefore a tension-caused register offset Delta P, is less, in particular on the path between the first two print units 04, 06, which follow each other at the short distance a1, so that the regulation for the first two print units 04, 06 in relation to the upper print unit 07, 08 can take place in the same way, and not additionally in relation to each other. A shorter distance a3 (for example 0.4 m to 1 m) again follows between the two print units 07, 08 of the upper H-print unit 11. A relative change takes place only at the print units 04, 06, with a large distance a2 to a subsequent print unit 07.

The regulation of the correction of the register offset Delta P by means of the correction value K as a function of the difference Delta S, consisting of the initially spontaneously rising and subsequently falling change of the tension S5 by a difference Delta S, is preferably performed as a proportional regulation, wherein a linear connection is preferably made between the difference Delta S of the tension S5 and the correction value K. In an advantageous manner, the regulating device 27 is embodied as a proportional regulator 27.

In an advantageous embodiment, the correction value K almost satisfies (in the range of the tensions S56 Delta S considered here) the equation K=a*Delta S, wherein a represents the pitch, and no constant member needs to be considered. For regulating the lower H-print unit 09 in respect to the upper H-print unit 11, the pitch a for the eight-unit tower 01 under consideration lies between 1/(35 daN/m/mm) and 1/(45 daN/m/mm), in particular around 1/(40 daN/m/mm) if the difference Delta S of the tension S5 is measured in daN/m, and the correction value K of the register offset Delta P on the circumference of the cylinder 12, 13, 14, 16 Is measured in mm.

For example, if a measured difference Delta S of the tension S5 for a cylinder diameter of approximately 230 mm is 10 daN/m, the angle of rotation position phi for the lower H-print unit 09 relative to the upper H-print unit 11 is corrected in such a way that an offset at the circumference of the changed cylinders 12, 13, 14, 16 by approximately 0.25 mm takes place. The change Delta phi of the angle of rotation position is proportional to the correction value K and the register offset Delta P. Therefore the change Delta phi of the angle of rotation position over a constant c considered over the circumference of the respective cylinders (12, 13, 14, 16) also is in a linear correlation to the difference Delta S, therefore Delta phi=a*c*Delta S applies for the value of the change of the relative angle of rotation position. The relative change Delta phi for the upper cylinder therefore is approximately 0.12° to 0.13° , for example. In place of the change Delta phi of the angle of rotation position, a change of the angular speed Delta $ can take place for a set time.

A different dependency of the correction to be taken into consideration exists for different qualities of the paper web 03, so that preferably a quality value Q, or also a quality function Q, for taking the existing type of paper web 03 (moisture behavior and/or tension-expansion characteristics, etc.) should be superimposed on the said dependency. The desired correction by the correction value K, or the change Delta phi of the angle of rotation position phi or the angular speed Delta $ is therefore a function of the tension 5, or the difference Delta S of the circumference of the cylinder 12, 13, 14, 16 to be corrected and the quality value Q.

In a preferred embodiment, the correction of the register offset Delta P is only performed by means of a register adjustment. A regulation of the tension S5 downstream of the last print unit 08 is not performed in this connection. In a preferred embodiment, the traction roller 22 is designed as a traction roller 22 which is regulated in respect to its number of revolutions, to which neither tension values nor torque values need to be assigned. The measured tension S5 is used in an advantageous manner for regulating the tension S1 (shown in dashed lines in FIG. 1) in order to meet the above mentioned requirement of a greater tension S1 in comparison to S5.

The method and a corresponding device for regulating the circumferential register for correcting the register offset Delta P, which occurs during the fixed printing operation in the form of short interferences, is particularly suitable, for example because of the flying change of paper rolls of identical quality. Following this interference, fixed conditions and the identical paper quality prevail as a rule.

In an advantageous embodiment each cylinder 12, 13, 14, 16 of each print unit has its own drive motor 17, 18, 19, 20. For the said correction of the registration offset Delta P, however, all drive motors 17, 18 of one of the two print units 04, 06, or all drive motors 17, 18 of the two lower print units 04, 06 are corrected simultaneously by the same value. What has been said should be correspondingly applied for a drive mechanism for each pair of forme cylinders 12, 16 with the assigned transfer cylinders 13, 14.

The method for regulating the circumferential register is also suitable for other configurations of the printing press than that of the eight-unit tower 01 with at least two print units 04, 06, 07, 08, provided it has several nips 04, 06, 07, 08, or print units 04, 06, 07, 08, which are spaced apart from each other in the running direction of the paper web 03, or also has printing locations 04, 06, 07, 08.

For example, this can be a printing press which has several bridge units arranged on top of each other, or several rubber-against-rubber print units, which are arranged next to each other, with a horizontal guidance of the paper web 03. In the same way, for all mentioned examples the respective first transfer cylinder 13 can also work together with a counter-pressure cylinder 14 embodied as a steel cylinder 14. Here, too, the tension S5 is measured downstream of the last print unit 08, and the print units 04, 06, 07 arranged upstream of the last print unit 08 are arranged by means of the difference Delta S, or the tension S5. This can again occur in groups of several successive print units 04, 06, or also with individual print units 04, 06, 07. In principle, the print units 04, 06, 07 are regulated in respect to the unchanged last print unit 08. As a rule, no relative change needs to take place between the first and second print units 04, 06, because they are not yet completely moistened throughout.

Besides the register, or ink, register, i.e. the exact relative position of two print images imprinted one after the other on the same side of the web 03, as a rule in different colors, the method in a non-represented embodiment is also suited in the same way to regulate the register between the two sequentially imprinted sides of the web 03. This is advantageous, for example, for an arrangement of two satellite print units 09, 11, each having one or several print positions. The web 03 passes successively through the satellite print units 09, 11 which are, for example, embodied as so-called nine-cylinder satellites or ten-cylinder satellites, wherein one side of the web 03 is imprinted in one of the print units 09, 11, and thereafter the other side of the web 03 in the other print unit 11, 09, in one or several colors.

For separate requirements, the measurement and evaluation of the difference Delta S in the tension S2, S3, S4, S5 can also take place between the individual nips 04, 06, 07, 08, and a change in the rotary position of the previous nips 04, 06, 07, 08 can be caused.

In case of greater differences Delta S within a large tension range of the tensions S2, S3, S4, S5, it is possible under certain circumstances to base the difference Delta S and the required correction of the register offset Delta P by the correction value K on a non-linear connection. However, in this case a corresponding functional connection can also be taken into consideration in the regulating device in a simple manner.

Lest of Reference Symbols

| | |
|---|---|
| 01 | Eight-unit tower |
| 02 | Roll changer |
| 03 | Web, pager web |
| 04 | Print unit, nip, double-printing group, print |
| | position |
| 05 | — |
| 06 | Print unit, nip, double-printing group, print |
| | position |
| 07 | Print unit, nip, double-printing group, print |
| | position |
| 08 | Print unit, nip, double-printing group, print |
| | position |
| 09 | H-print unit, lower, first |
| 10 | |
| 11 | H-print unit, upper, second |
| 12 | Cylinder, forme cylinder |
| 13 | Cylinder, transfer cylinder |
| 14 | Cylinder, counter-pressure cylinder, transfer |
| | cylinder, steel cylinder |
| 15 | — |
| 16 | Cylinder forme cylinder |
| 17 | Drive motor (04) |
| 18 | Drive motor (06) |
| 19 | Drive motor (07) |
| 20 | — |
| 21 | Drive motor (08) |
| 22 | Traction member, traction roller |
| 23 | Draw-in devica |
| 24 | Area of increased thickness |
| 25 | — |
| 26 | Measuring device, sensors, measuring roller |
| 27 | Regulating device, computer, control station |
| | computer, proportional regulator |
| 28 | Capture roller |
| a1 | Distance (04, 06) |
| a2 | Distance (06, 07) |
| a3 | Distance (07, 08) |
| K | Correction value |
| Delta phi | Change of the angle of rotation position |
| Delta $ | Change of the angular speed |
| S1 | Tension |
| S2 | Tension |
| S3 | Tension |
| S4 | Tension |
| S5 | Tension |
| S-soll | Set value |
| Delta S | Difference |

1. A method for regulating a circumferential register in a web-fed rotary printing press, having at least two print units (04, 06, 07, 08) through which a web (03) passes sequentially, wherein an actual value of a tension (S5) of the web (03) is determined and, as a function of this tension (S5), an angular position (Delta phi) and/or an angular speed (Delta $) of at least one cylinder (12, 13, 14, 16) of a first print unit (04, 06, 07, 08) is regulated in relation to the angular position (Delta phi) and/or angular speed (Delta $) of at least one cylinder (12, 13, 14, 16) of a second print unit (04, 06, 07, 08), characterized in that the tension (S5) is determined downstream of a print unit (08) which is the last in the production direction, and that as a function of this tension (S5) the regulation of the angular position (Delta phi) and/or the angular speed (Delta $) takes place at a print unit (04, 06, 07), which is arranged upstream of the last print unit (08), viewed in the production direction.

2. The method in accordance with claim 1, characterized in that a difference (Delta S) between the measured tension (S5) and (Delta phi) and/or angular speed (Delta $) is changed as a function of this difference (Delta S).

3. A method for regulating a circumferential register in a web-fed rotary printing press, having at least two print units (04, 06, 07, 08) through which a web (03) passes sequentially, wherein an actual value of a tension (S5) of the web (03) is determined and a difference (Delta S) from a set value (S-soll) is formed and wherein by means of this difference (Delta S) an angular position (Delta phi) and/or an angular speed (Delta $) of at least one cylinder (12, 13, 14, 16) of a first print unit (04, 06, 07, 08) is regulated in relation to at least one cylinder (12, 13, 14, 16) of a second print unit (04, 06, 07, 08), characterized in that the value of the required change of the angular position (Delta phi) and/or an angular speed (Delta $) is formed as a function of a quality of a web (03).

4. The method in accordance with claim 3, characterized in that the tension (S5) is determined downstream of the last print unit (08) in the production direction.

5. A method for regulating a circumferential register in a web-fed rotary printing press, having at least two print units (04, 06, 07, 08) through which a web (03) passes sequentially, wherein an actual value of a tension (S5) of the web (03) is determined and a difference (Delta S) from a set value (S-soll) is formed and wherein by means of this difference (Delta S) an angular position (Delta phi) and/or an angular speed (Delta $) of at least one cylinder (12, 13, 14, 16) of a first print unit (04, 06, 07, 08) is regulated in relation to at least one cylinder (12, 13, 14, 16) of a second print unit (04, 06, 07, 08), characterized in that the difference (Delta S) of the tension (S5) is determined downstream of the last print unit (08) in the production direction.

6. The method in accordance with claims 1, 3 or 5, characterized in that as a function of the tension (S5), the angular position (Delta phi) and/or the angular speed (Delta $) of at least one cylinder (12, 13, 14, 16) of the print unit (04) which is first in the production direction is changed.

7. The method in accordance with claims 1, 3 or 5, characterized in that as a function of the tension (S5) angular positions (Delta phi) and/or angular speeds (Delta $) of cylinders (12, 13, 14, 16) of the first two print units (04, 06) in are changed.

8. The method in accordance with claim 7, characterized in that the change of the angular position (Delta phi) and/or the angular speed (Delta $) of the two print units (04, 06) is made by the same amount.

9. The method in accordance with claims 2, 3 or 5, characterized in that angular positions (Delta phi) and/or angular speeds (Delta $) of cylinders (12, 13, 14, 16) of the first two print units (04, 06) in the production direction of the web (3) which are embodied as first H-print unit (09), are changed simultaneously and by the same value as a function of the difference (Delta S) in the tension (S5) downstream of the print units (07, 08), which are embodied as a second H-print unit (11).

10. A method for regulating a circumferential register in a web-fed rotary printing press, having a first print unit (09), which has several printing locations (04, 06, 07, 08) for at least one side of a web (03), and a second print unit (11), having several printing locations (07, 08, 04, 06) for the same and/or the other side of the web (03), wherein an actual value of a tension (S5) in a web (03) passing through the print units (09, 11) is determined downstream of the last printing location in the production direction, characterized in that a difference (Delta S) is formed between the tension (S5) and a set value (S-soll), and that as a function of this difference (Delta S), an angular position (Delta phi) and/or an angular speed (Delta $) of at least two cylinders (12, 13, 14, 16) of the first print unit (09), which has several printing locations (04, 06, 07, 08), is regulated in relation to the angular position (Delta phi) and/or an angular speed (Delta $) of at least one cylinder (12, 13, 14, 16) of the second print unit (11), which has several printing locations (07, 08, 04, 06), and that the angular position (Delta phi) and/or an angular speed (Delta $) of the cylinders (12, 13, 14, 16) to be regulated of the first print unit (09), which has several printing locations (04, 06, 07, 08), are all regulated by the same value.

11. The method in accordance with claims 1, 3, 5 or 10, characterized in that the circumferential register of a web-fed rotary printing press having two H-print units (09, 11) is regulated by means of the method.

12. The method in accordance with claim 10, characterized in that the circumferential register of a web-fed rotary printing press having two satellite print units (09, 11) is regulated by means of the method.

13. The method in accordance with claims 2, 5 or 10, characterized in that the value of the required change of the angular position (Delta phi) and/or of the angular speed (Delta $) is determined as a function of the difference (Delta S) in the tension and a quality of the web (03).

14. The method in accordance with claims 2, 3, 5 or 10, characterized in that the value of the change of the angular position (Delta phi) and/or of the angular speed (Delta $) is formed by means of a linear relation between the difference (Delta S) of the tension (S5) and the change of the angular position (Delta phi) and/or of the angular speed (Delta $).

15. The method in accordance with claims 1, 3, 5 or 10, characterized in that a tension (S1, S2, S3, S4, S5) along the path from a roll changer (02) to a traction member (22) is only regulated between the roll changer (02) and the first print unit (04).

16. The method in accordance with claims 1, 3, 5 or 10, characterized in that the tension (S1) upstream of the first print unit (04) is set to be higher by at least 10 daN/m than the tension (S5) downstream of the last print unit (08).

17. The method in accordance with claims 1, 3, 5 or 10, characterized in that a correction of the register offset (Delta P) during the fixed printing operation is performed without a regulation of the tension (S2, S3, S4, S5) and without an optical detection system merely by means of the functional connection with the tension (S5) downstream of the last print unit (S8) and, if required, the quality of a web (03).

18. The method in accordance with claims 1, 3, 5 or 10, characterized in that a traction roller (22) arranged downstream of the last print unit (08) is regulated to a constant number of revolutions.

19. The method in accordance with claims 2, 3, 5 or 10, characterized in that, following a spontaneous increase of the tension (S5), first a change in the angular position (Delta phi) and/or the angular speed (Delta $) in a first direction takes place in accordance with the difference (Delta S), and thereafter, following the reduction of the difference (Delta S), a change in the opposite direction occurs.
